(19) United States
(12) Patent Application Publication
(10) Pub. No.: US 2010/0082375 A1
(43) Pub. Date: Apr. 1, 2010

(54) ASSET INTEGRITY MANAGEMENT SYSTEM AND METHODOLOGY FOR UNDERGROUND STORAGE

(75) Inventor: CLAUDIA VIVALDA, Italy (FR)

Correspondence Address: SCHLUMBERGER CANADA LIMITED, 9450 17TH AVE, EDMONTON, AB, T6N 1M9, CA

(73) Assignee: SCHLUMBERGER TECHNOLOGY CORP., SUGAR LAND, TX (US)

(21) Appl. No.: 12/236,292

(22) Filed: Sep. 23, 2008

(51) Int. Cl. G06F 17/30; G06F 9/44; G06F 17/50

(52) U.S. Cl. 705/7

(57) ABSTRACT

A technique facilitates asset integrity management of underground storage assets, such as underground carbon dioxide storage sites. The technique comprises establishing a paradigm for asset integrity management comprising element fields related to elements such as asset life cycle, implementation procedures, technologies, tools, and methods to obtain and evaluate data, and control/mitigation measures. Data related to the element fields is processed based on relationships established by the paradigm. Based on the analysis, information related to the integrity of the underground storage asset is output lot-use in managing the underground storage asset.

### BACKGROUND OF THE INVENTION

A variety of substances can be stored in underground storage sites. For example, substantial current interest exists with respect to carbon capture and storage projects. Substances, such as carbon dioxide, are handled and directed to suitable underground storage. The storage sites can be purposely formed or found naturally occurring in various geological regions.

Long term underground storage of carbon dioxide, however, presents a variety of challenges. Challenges arise from issues related to the term of the storage, the properties and behavior of carbon dioxide during and after injection, and uncertainties surrounding geological media, such as saline aquifers. Attempts have been made at developing platforms to provide guidance for storage of carbon dioxide, but existing platforms/systems ignore a variety of important elements, such as life cycle characteristics and control/mitigation measures that can be implemented.

### BRIEF SUMMARY OF THE INVENTION

In general, the present invention provides a methodology and system for asset integrity management of underground storage assets, such as underground carbon dioxide storage sites. The methodology and system establish a paradigm for asset integrity management comprising element fields related to elements such as asset life cycle, implementation procedures, technologies to obtain/evaluate data, and control/mitigation measures. Data related to the element fields is provided to a processor-based system for processing based on relationships established by the paradigm. For example, the data can be processed to analyze and output information related to the integrity of the underground storage asset, e.g. output a risk assessment of the asset.

### BRIEF DESCRIPTION OF THE DRAWINGS

Certain embodiments of the invention will hereafter be described with reference to the accompanying drawings, wherein like reference numerals denote like elements, and:

FIG. 1 is a schematic illustration of a processor-based system having a plurality of element fields related to asset integrity management, according to an embodiment of the present invention;

FIG. 2 is a flowchart illustrating one example of a general methodology for integrity management of an underground storage asset, according to an embodiment of the present invention;

FIG. 3 is a schematic representation of one example of a processing system used to process data related to asset integrity management, according to an embodiment of the present invention;

FIG. 4 is a schematic illustration of a paradigm for asset integrity management having a plurality of element fields, according to an embodiment of the present invention;

FIG. 5 is a flowchart illustrating a procedural approach based on the paradigm for asset integrity management, according to an embodiment of the present invention;

FIG. 6 is a flowchart illustrating a related procedural approach based on another aspect of the paradigm for asset integrity management, according to an embodiment of the present invention: and

FIG. 7 illustrates one example of the paradigm implemented in a workflow with processes to assess and manage asset integrity, according to an embodiment of the present invention.

### DETAILED DESCRIPTION OF THE INVENTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a methodology and system that enable integrity management for assets, such as underground storage assets. One example of an asset for which the methodology is particularly amenable is a carbon dioxide underground storage site. The methodology and system provide a user with an objective and consistent way to manage the integrity of the asset during its life cycle. With respect to carbon dioxide underground storage sites, assessment methodology can be used to ensure the site performs according to defined specifications in safe conditions over the short term, midterm, and long term life of the asset. In the example of an underground storage asset, the defined specifications may comprise a variety of specifications, including injectivity, capacity, and containment.

According to one embodiment of the invention, a paradigm is provided in which a plurality of elements, defined by element fields, are integrated. By way of example, the element fields can be integrated according to the paradigm on a processor-based system. The elements may include asset life cycle, implementation procedures/processes for asset integrity management, technologies for monitoring and evaluating the asset, and control or mitigation measures to assure a systemic approach for asset integrity management. The paradigm can be implemented into a workflow that addresses the relevant tools, techniques, and methods necessary to provide a workable system and methodology for integrity management of the asset.

The system and methodology comprise a variety of aspects that are useful in managing carbon dioxide underground storage sites and other assets. The paradigm described above can be specifically designed for management of the integrity of carbon dioxide underground storage sites during the asset life cycle. The paradigm represents an integrated system able to assess and manage a carbon dioxide storage site from selection to decommissioning with surveillance of the asset throughout its life. A workflow is selected to implement the paradigm. By way of example, the workflow may incorporate a classical risk analysis approach with features that are peculiar to carbon dioxide storage sites. Effectively, the methodology provides a platform that integrates the various methods, technologies, and tools used in implementing the workflow during the asset life cycle. In this example, a processor-based system is used to integrate within the unique paradigm four main element fields comprising asset life cycle, implementation procedure, technologies, and control/mitigation measures to assure a systemic approach for integrity management of the underground carbon dioxide storage site.

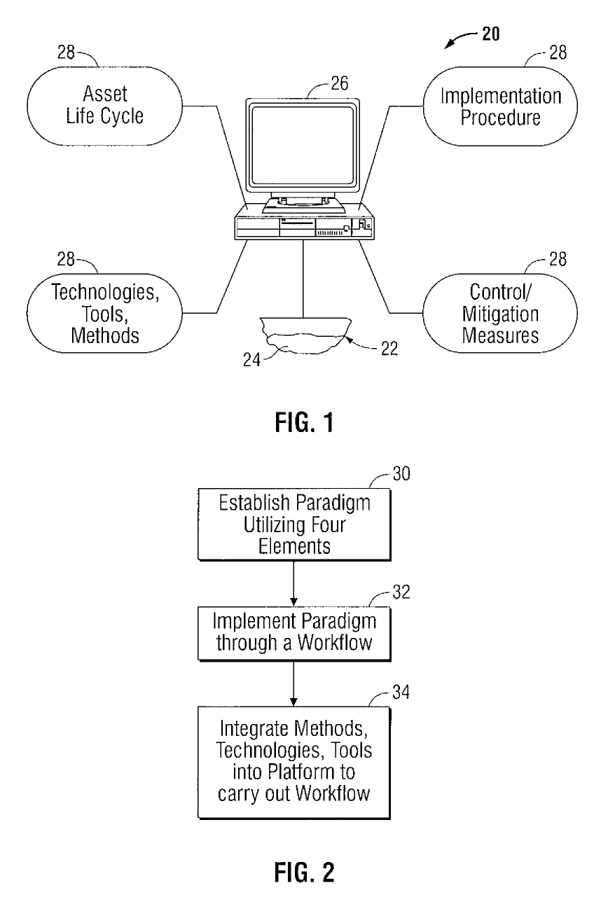

An example of an asset integrity management system 20 is illustrated in FIG. 1. In this embodiment, an asset 22 is illustrated in the form of an underground storage site, such as an underground carbon dioxide storage site 24. Data on asset 22 is provided to a processor-based system 26, such as a computer-based system, for analysis according to a paradigm for managing the integrity of the asset, e.g. the underground carbon dioxide storage site. The paradigm may include a plurality of elements defined by element fields, and four main elements 28 are illustrated in the example of FIG. 1. In the specific example of an underground carbon dioxide storage site, the paradigm includes asset life cycle; implementation procedures/processes for asset integrity management; technologies for obtaining and evaluating preliminary and ongoing data from the asset 22; and control and mitigation measures. Data related to the elements 28 is processed on processor-based system 26 to assure a systemic approach for asset integrity management in the near term, midterm, and long term life of the asset.

As illustrated generally by the flowchart of FIG. 2 a paradigm is initially established to utilize the relationships established with respect to the four elements 28, as illustrated by block 30. The paradigm is then implemented through a workflow that can be designed for the specific asset, such as the carbon dioxide underground storage site, as illustrated by block 32. The paradigm and implementation of the workflow rely on integrating methods, technologies, and tools into an appropriate platform for carrying out the workflow, as illustrated by block 34. By way of example, the processor-based system 26 can be used to establish a platform for integrating the various methods/models, technologies, and tools related to integrity management of the carbon dioxide underground storage site.

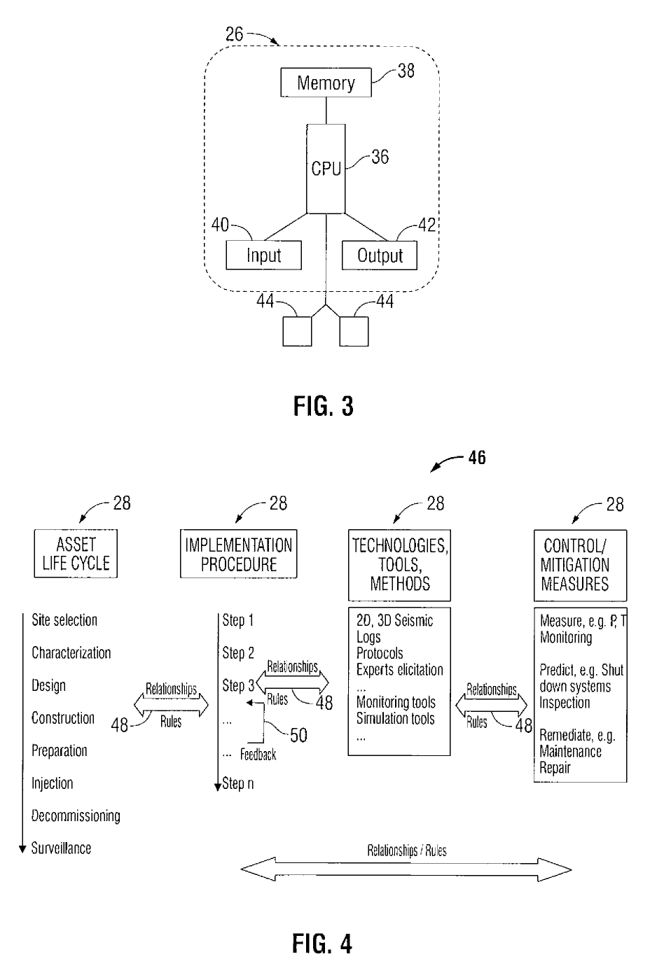

Interrelationships between the four elements 28 can be established on processor-based system 26 for carrying out the processes, evaluations, and assessments associated with managing asset 22. The processor-based system 26 may comprise a variety of processing systems, such as computer-based systems having one or more processors located at one or more locations. One example of a suitable processing system is illustrated in FIG. 3. In this example, processor-based system 26 is a computer-based system having a central processing unit (CPU) 36. Central processing unit 36 is a microprocessor-based CPU that enables rapid processing of data/criteria related to the characterization of asset 22 and the monitoring and evaluation of the asset 22 over its life cycle. Furthermore, CPU 36 is operatively coupled to a memory 38, as well as an input device 40 and an output device 42. Input device 40 may comprise a variety of devices, such as a keyboard, mouse, voice-recognition unit, touchscreen, devices to receive data from field measurements, other input devices, or combinations of such devices. Output device 42 may comprise a visual and/or audio output device, such as a monitor having a graphical user interface. The actual processing may be done on a single device or multiple devices.

Memory 38 can be used to store a variety of asset-related data along with analytical programs for processing the asset-related data and the data obtained from ongoing acquisition of data during management of the asset over its life cycle. Data can be entered into processor-based system 26 via input device 40. For example, a wide variety of data related to characteristics of a specific carbon dioxide underground storage site can be entered for processing. Additionally, data can be obtained during initial site characterization and during the ongoing asset integrity management via a variety of sensor systems 44 deployed in or around a specific carbon dioxide underground storage site or other asset.

The processor-based system 26 enables interconnection of elements 28 through specific relationships and rules that are established to permit influence and exchange between the element fields. Each element field comprises the set of characteristics, properties, techniques, and tools that belong to the corresponding element 28 and that can affect other elements 28. For example, the field of the asset life cycle element may be represented by life cycle phases, such as site selection, characterization, design, construction, preparation, injection, decommissioning, and surveillance. The other elements 28 have their own unique element fields and cooperate in creating a static paradigm that frames the carbon dioxide asset integrity management system. As discussed in greater detail below, the paradigm may be implemented in a workflow with processes to assess and manage the asset integrity dynamically over time.

In one embodiment, the workflow is structured in a manner with predetermined relationships and rules objectively and coherently defined to connect the different fields of elements 28. The platform established by the interconnected elements 28 can be designed as an open platform allowing external computations, evaluations, data, and other external influences to be plugged in through, for example, processor-based system 26. In managing asset integrity, the workflow principles often are strongly related to risk assessment. For example, the paradigm and its elements 28 enable assessment and management of a carbon dioxide underground storage site via a close interconnection between field data acquisition and the processing of data for risk assessment. Initial risk assessment can be carried out in early stages of the workflow during, for example, pre-characterization and characterization phases of the workflow utilized in managing asset integrity. In fact, preliminary risk assessment can be used to drive the characterization needs, and then suitable data can be recorded via, for example, processor-based system 26. For instance, the reduction of epistemic uncertainties can heavily modify initial predictions.

Throughout the life cycle of asset 22, the level of detail with respect to information available for input into processor-based system 26 can vary, and consequently the thoroughness of the output/results can vary. However, the paradigm can be designed and/or adjusted so the overall asset integrity management system 20 is able to manage this variability and provide output/outcomes more or less detailed depending on the phase of the life cycle. The level of detail can also be adjusted according to other factors, such as customer needs and the level of unknowns and uncertainties.

According to one example, the asset integrity management system 20, implementing the workflow, is designed to process applicable data and output an assessment of the system performance in terms of injectivity, capacity, and containment over time. The system also is able to process, evaluate, and output information related to the risk and/or the residual risk associated with the asset 22. The risks can be related to a variety of factors, including geological factors, technical factors, financial factors, operational factors, and other factors that can affect the integrity of the asset over time. The asset integrity management system 20 can also be designed to evaluate, determine, and output a set of cost balanced control and mitigation measures that are used to prevent the asset risks from exceeding predetermined acceptable or accepted levels.

Referring generally to FIG. 4, one example of a paradigm 46 is illustrated for the integrity management of a carbon dioxide underground storage asset. In this example, the paradigm 46 is based on the four elements 28 discussed above, namely asset life cycle, implementation procedure, technologies, and control/mitigation measures. The elements 28 are interconnected by pre-established relationships and rules, as indicated by arrows 48. The specific relationships and rules can vary from one asset integrity management application to another and depend, at least in part, on the element field for each element 28. By way of example, the various relationships and rules are programmed into processor-based system 26 to enable initial and ongoing evaluation and management of the asset 22. One example of pre-established relationships and rules can be described as follows: during injection (life cycle element in the paradigm), a procedure for site maintenance (implementation procedure in the paradigm)-a relationship-includes a request-rule-not to shut down the injection unless the carbon dioxide source, e.g. a power plant, is shut down. Maintenance staffs and/or processor-based system 26 rely on data from, for example, monitoring tools (technologies, tools, and methods element in the paradigm) to maintain the site in safe conditions. In the case of an emergency requiring an unplanned shutdown of the injection (control/mitigation measures in the paradigm), contingency measures are in place to, for example, vent the carbon dioxide to the atmosphere and pay the corresponding credits. Many other relationships and rules can be established for various actions and stages of the asset integrity management, and processor-based system 26 can be utilized in carrying out these rules and relationships.

As illustrated, the field of the asset life cycle element 28 can be represented by life cycle phases including site selection, characterization, design, construction, preparation, injection, decommissioning, and surveillance. The field of the implementation procedure clement 28 can vary and may be designed, adjusted, and changed according to the field of the asset life cycle element 20 and the field of the technologies element 28. For example, the phases of the life cycle and the technologies utilized in managing the integrity of the asset affect the implementation procedure, and the implementation procedure is selected in light of the other field characteristics. The implementation procedure also can vary over the life cycle of the asset. In many applications, the implementation procedure includes one or more feedback loops 50 that can be used to repeat procedural segments based on receipt of data from, for example, the technologies used to characterize and/or monitor the asset.

Examples of technologies available for monitoring the asset during its life cycle include two-dimensional and three-dimensional seismic logs, sensor systems/monitoring tools, simulation tools, modeling tools, protocols, and other tools that can be employed to evaluate a given asset according to the phase of the life cycle and the implementation procedure. Based on the overall paradigm and the data collected and processed by the various technologies, the control/mitigation element 28 can be used to derive from a risk assessment indications about the need for taking appropriate action including: adjusting the measurement and monitoring of the asset; outputting predictions: and indicating and/or controlling various remediation and maintenance activities related to the integrity of the asset.

It should be noted that the paradigm 46 is designed to encompass and account for the peculiarities of a specific asset. In managing the integrity of a carbon dioxide underground storage asset, for example, the geological system can comprise continuous media with properties that are not fully known. As a result, they cannot be easily associated with a failure rate. Each geological site is unique and knowledge about the asset often is obtained by interpreting relevant geophysical data, such as seismic data, and measuring underground strata characteristics, including (low properties, mechanical properties, petrophysical properties, and other characteristics. Initial characterization of the asset is important in establishing the paradigm that will be most helpful in providing a risk assessment and other information related to the ongoing integrity management of the asset. The underground storage asset for carbon dioxide typically has no active components, and therefore the response of the asset to injected carbon dioxide is governed by physical processes, such as carbon dioxide induced physical, chemical, and mechanical effects.

With respect to the asset life cycle element 28, the pre-characterization

and characterization of the carbon dioxide underground storage asset is important to enable successful application of paradigm 46. Sometimes, the carbon dioxide underground storage asset can be decomposed into two primary subsystems based on the engineered system and the geological system. The engineered system may comprise the well or wells, the injection facility, and other designed systems, while the geological system comprises the reservoir into which carbon dioxide is to be injected, as well as caprock, aquifers, subsurface strata, and other geological features. By characterizing the asset properly, the risk analysis is more reliable initially and during ongoing monitoring of the asset.

During initial characterization or pre-characterization of the asset 22, a variety of data can be collected and, for example, input into processor-based system 26. By way of example, known data on existing characteristics and features of a particular asset can be obtained. The asset can then be broken down into subsystems, and each subsystem can be analyzed to identify mechanisms that can potentially lead to the loss of asset performance in terms of capacity, injectivity, and containment. The mechanisms can then be evaluated and ranked, and appropriate mitigation measures can be determined for some or all of the mechanisms. Uncertainties can also be identified and characterization needs and solutions can be prioritized. All of these mechanisms and characteristics can be utilized in determining the implementation procedure element 28.

Subsequently, a more detailed or comprehensive characterization of the asset can be performed, and the data can be entered into processor-based system 26. Depending on the technologies available, the characterization may comprise two-dimensional and three-dimensional seismic surveys, logging, drilling one or more wells to obtain data on the underground storage asset, and carbon dioxide injection tests. The characterization enables accumulation of substantial data on capacity, injectivity, and containment qualities of the carbon dioxide underground storage asset. The technologies utilized may also comprise a variety of modeling tools to help model the asset and its performance.

The implementation procedure and technology elements 28 may be designed and selected to facilitate the asset integrity management by, for example, identifying and evaluating risk. During the characterization, injection, and surveillance phases of the life cycle, for example, risk factors can be identified and analyzed to enable implementation of suitable control and mitigation measures as described above with respect to the control and mitigation element 28. In the carbon dioxide underground storage asset example, risk can be identified and evaluated with respect to actual or potential leakage, such as leakage through confining beds or leakage due to preferential dissolution and creation of channels through confining layers of the underground storage site. Risk can also be associated with displacement of saline groundwater into a potable aquifer or migration of the injected carbon dioxide into a potable water zone. Other risk factors can be associated with leakage through abandoned or closed wells, or along fault lines in the subterranean asset region. The processor-based system 26 can be programmed with a variety of available models and simulations that enable a probabilistic analysis with respect to the risk factors.

Depending on the type of risk factor and the imminence of the risk factor, a variety of remediation measures, such as preventive and/or corrective remediation measures, can be identified and implemented. For example, processor-based system 26 can be used to analyze data collected on the asset according to the paradigm 46 and the rules and relationships established between the elements 28. The analysis can be updated throughout the life cycle of the asset on, for example, a periodic basis to enable monitoring of changes and to increase the data/knowledge regarding the asset. The updated analysis also enables application of the remediation measures as an iterative process involving continued observation and continued correction to reduce risk.

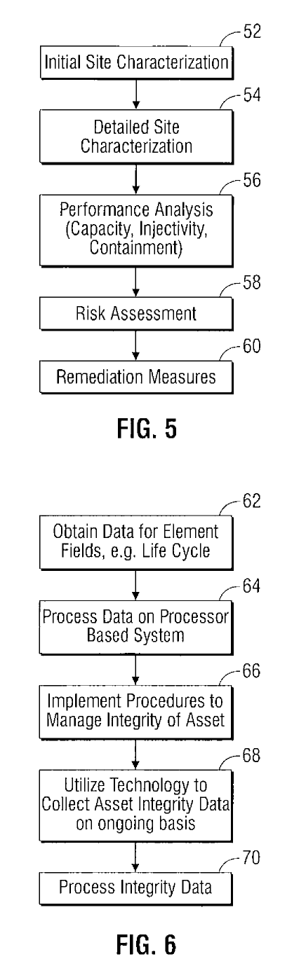

Referring generally to FIG. 5, a simple flowchart is provided as one example of a general methodology for asset integrity management of a carbon dioxide underground storage asset according to paradigm 46. Once a potential storage asset is identified, an initial site characterization is performed, as indicated by block 52. Subsequently, a detailed site characterization is performed as indicated by block 54. The detailed site characterization may utilize a variety of technologies, methods, models, simulations, and other tools to expand the data and understanding of the asset. Based on this understanding, a performance analysis is conducted by, for example, processor-based system 26, as indicated by block 56. In this example, the performance analysis emphasizes potential performance of the asset based on capacity, injectivity, and containment. The knowledge/data gained from the site characterization and performance analysis can be used to provide a risk assessment, as indicated by block 58. The risk assessment enables determination of appropriate remediation measures to remove or mitigate the risk, as illustrated by block 60. The performance analysis and risk assessment can be accomplished within the paradigm 46 based on the relationships and rules established between the element fields used to define each clement 28.

Another example of how the paradigm 46 can be utilized for asset integrity management involving, for example, carbon dioxide underground storage sites is illustrated in the flowchart of FIG. 6. In this example, data is obtained and entered into processor-based system 26 for the element fields of elements 28, as indicated by block 62. The data is processed on the processor-based system 26 according to the technologies and tools implemented for a given application and according to the relationships and rules between elements 28, as indicated by block 64. The analysis enables implementation of procedures to construct and/or manage the integrity of the asset, as indicated by block 66. The management may include, for example, determining risk factors and reducing those risk factors. Technology, such as sensor systems, simulation systems, monitoring systems, models, algorithms, and other tools can be used to collect and evaluate asset integrity data on an ongoing basis, as illustrated by block 68. The ongoing integrity data is continually processed, as indicated by block 70, to enable maintenance of the integrity of the asset over the asset life cycle.

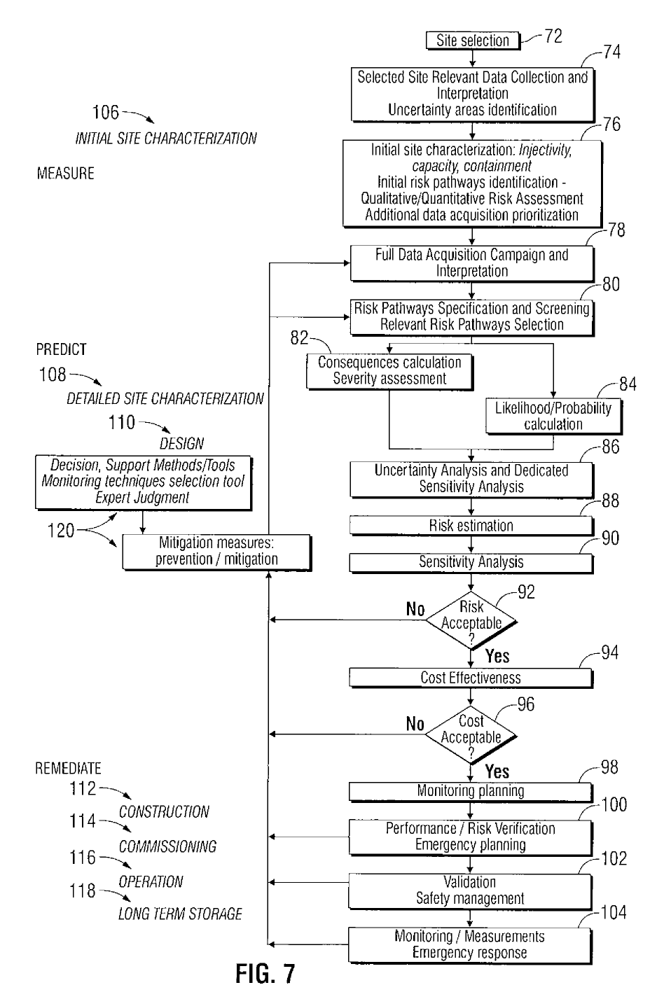

As discussed above, the paradigm 46 generally is implemented in a workflow that addresses the relevant tools, techniques, and methods utilized in the asset integrity management system. One example of a workflow for management of the integrity of a carbon dioxide underground storage site is illustrated in FIG. 7. The workflow can be implemented as a support tool on processor-based in system 26.

In the example illustrated, a storage site is initially selected, as indicated by block 72. Selecting the underground storage site can be based on a variety of geological analysis tools and expert judgment. Following initial site selection, a wide variety of data is collected on the underground storage asset, and areas of uncertainty are identified, as illustrated by block 74. A variety of sensor systems and other technologies can be used to facilitate data collection. Once insufficient data is collected, an initial storage site characterization is conducted to evaluate, for example, injectivity, capacity, and containment characteristics of the storage site. At this stage, tools embodied in processor-based system 26 can be used to identify initial risk pathways through both qualitative and quantitative analyses, as indicated by block 76. If the storage site is feasible, a full data acquisition campaign is conducted, and the data is analyzed and interpreted, as indicated by block 78.

Data resulting from the full data acquisition can be processed on processor-based system 26 for evaluation and determination of potential risk pathways. Those risk pathways can be screened and ranked for relevance, as indicated by block 80. For example, potential consequences of risk pathways can be calculated to provide a severity assessment (see block 82), and estimations can be made as to the likelihood or probability of a given consequence (see block 84). The severity assessment and probability calculation can be repealed in an iterative process based on additional data and/or changes to the utilization of the underground storage asset. Additionally, an uncertainty analysis and a dedicated sensitivity analysis can be performed on processor-based system 26, as indicated by block 86.

The results of the uncertainly and sensitivity analyses facilitate an estimation of risk, as indicated by block 88, based on one or more risk assessment tools within technology element 28. The sensitivity analysis can then again be performed, as indicated by block 90, and a decision can be made as to whether the risk is within acceptable levels, as indicated by decision block 92. If the risk is not acceptable, the workflow can be returned to data acquisition and interpretation block 78 or to block 80 for further risk pathway screening and selection.

If the risk is acceptable, then the underground storage asset can be evaluated on a cost effectiveness basis, as indicated by block 94. By way of example, the cost effectiveness can be evaluated according to predetermined parameters and algorithms on processor-based system 26. Upon completion of the cost effectiveness analysis, a determination is made as to whether the cost is acceptable, as indicated by decision block 96. If the cost is not acceptable, the workflow can be returned to data acquisition and interpretation block 78 or to block 80 for further evaluation.

If the cost is within acceptable levels, monitoring plans are initiated, as indicated by block 98 for monitoring of the carbon dioxide underground storage asset over its life cycle. Along with monitoring, performance/risk verification programs as well as emergency planning programs can be selected and implemented, as indicated by block 100. Similarly, validation and safety management programs can be implemented for use during operation of the underground storage asset over the asset life cycle, as indicated by block 102. The long term storage of carbon dioxide in the underground storage asset is monitored and measured, and based on the monitoring/measuring, appropriate responses or adjustments are made, as indicated by block 104.

Generally, the illustrated workflow can be described in stages, including an initial site characterization stage 106, a detailed site characterization stage 108, a design stage 110, and a construction stage 112. Following construction, the asset has a commissioning stage 114, followed by an operation stage 116, in which, for example, carbon dioxide is injected into the storage asset, and a long term storage stage 118. During the various stages, data collection and analyses can be conducted on processor-based system 26, to make measurements, predictions, and appropriate remediation. Much of the analysis and decision making is performed on an iterative basis via processor-based system 26 during initial site characterization and over the life cycle of the asset. During the iterative process, a variety of decision, support, and mitigation methods and tools (including expert judgment) can be added or used to supplement the analysis, as indicated by blocks 120.

The paradigm 46 described herein is adjustable by adding or subtracting elements and changing element fields. Additionally, the paradigm 46 can be implemented according to a variety of workflows. The overall paradigm and the selected workflow can be influenced by environmental factors, characteristics of the substance to be stored underground, technology available for collecting data, processing capabilities, available models and simulations, and other factors. Additionally, remediation measures can be conducted as a result of intervention based on information output to a user, or the remediation measures can be automated in whole or in part. The paradigm and workflow are designed and selected to provide a methodology for mastering the integrity of a storage site, such as a carbon dioxide storage site, during its life cycle. The methodology utilizes an integrated and systemic approach that relies on rules and relationships between all or many aspects of the overall workflow.

Accordingly, although only a few embodiments of the present invention have been described in detail above, those of ordinary skill in the art will readily appreciate that many modifications are possible without materially departing from the teachings of this invention. Such modifications are intended to be included within the scope of this invention as defined in the claims.

What is claimed is:

1. A method for managing the integrity of an underground storage asset, comprising:
determining relationships between elements of an underground storage asset to establish a paradigm for maintaining asset integrity;
obtaining data related to a life cycle element of an underground storage asset;
implementing a procedure element to govern management of the integrity of the underground storage asset;
utilizing a technology element to obtain and evaluate the data related to managing the integrity of the underground storage asset over time; and
processing the data according to a control clement to determine appropriate control measures for maintaining the integrity of the underground storage asset.

2. The method as recited in claim 1, wherein obtaining data comprises obtaining data for initial asset characterization of an underground carbon dioxide storage asset.

3. The method as recited in claim 2, wherein processing the data comprises evaluating the data to make a risk assessment as to the life cycle of the underground storage asset.

4. The method as recited in claim 2, wherein processing the data comprises analyzing the performance of the underground storage asset over time.

5. The method as recited in claim 2, wherein processing the data comprises analyzing the performance of the underground storage asset in terms of at least injectivity, capacity, and containment over time.

6. The method as recited in claim 2, wherein processing the data comprises making a preliminary risk assessment.

7. The method as recited in claim 2, wherein processing the data comprises performing an uncertainty analysis.

8. The method as recited in claim 2, wherein processing the data comprises utilizing simulation tools and probabilistic models.

9. The method as recited in claim 1, further comprising performing a risk mitigation action based on the data to help maintain the integrity of the underground storage asset.

10. A method, comprising:
establishing a paradigm for asset integrity management comprising element fields of: asset life cycle; implementation procedures; technologies for obtaining and evaluating data on the asset; and control and mitigation measures:
using a processor-based system to interconnect the element fields through relationships and rules that enable the element fields to influence each other; and
providing a risk assessment based on analysis of data related to the element fields via the processor-based system.

11. The method as recited in claim 10, wherein establishing comprises establishing the paradigm for management of an underground carbon dioxide storage asset.

12. The method as recited in claim 11, further comprising:
collecting data related to the element fields; and
entering the data into the processor-based system.

13. The method as recited in claim 11, wherein providing a risk assessment comprises providing an assessment of system performance in terms of injectivity over time.

14. The method as recited in claim 11, wherein providing a risk assessment comprises providing an assessment of system performance in terms of capacity over time.

15. The method as recited in claim 11, wherein providing a risk assessment comprises providing an assessment of system performance in terms of containment over time.

16. The method as recited in claim 11, further comprising utilizing the processor-based system to establish mitigation measures to limit the potential for asset risks exceeding an acceptable level.

17. A system for managing the integrity of an underground storage asset, comprising:
a computer-based system having an output device and an input device for entering data establishing element fields related to an underground storage asset, the computer-based system having a processor programmed according to a paradigm for integrity management of the underground storage asset, wherein the data is processed according to the paradigm to provide a risk assessment as to the integrity of the underground storage asset over the life of the underground storage asset.

18. The system as recited in claim 17, wherein the computer-based system updates the risk assessment periodically over the life of an underground carbon dioxide storage asset.

19. The system as recited in claim 17, wherein data is entered to establish an element field related to asset life cycle.

20. The system as recited in claim 17, wherein data is entered to establish an element field related to implementation procedures for asset integrity management.

21. A method, comprising:
obtaining data related to characterization of an underground carbon dioxide storage asset;
processing the data on a computer-based system to characterize the underground carbon dioxide storage asset; and
outputting an assessment of underground carbon dioxide storage asset performance in terms of injectivity, capacity, and containment based on the data and the characterization of the underground carbon dioxide storage asset.

22. The method as recited in claim 21, wherein obtaining data comprises obtaining data initially and during the life of the underground carbon dioxide storage asset.

23. The method as recited in claim 21, wherein obtaining data comprises obtaining data to establish element fields including an asset life cycle clement field.

24. The method as recited in claim 21, wherein processing the data comprises assessing risk related to operation and post-operation of the underground carbon dioxide storage asset.
